(19) United States
(12) Patent Application Publication
(10) Pub. No.: US 2018/0231681 A1
(43) Pub. Date: Aug. 16, 2018

(54) RESERVOIR RESISTIVITY CHARACTERIZATION INCORPORATING FLOW DYNAMICS

(71) Applicant: KING ABDULLAH UNIVERSITY OF SCIENCE AND TECHNOLOGY, Thuwal (SA)

(72) Inventors: Klemens KATTERBAUER, Thuwal (SA); Shuyu SUN, Thuwal (SA); Ibrahim HOTEIT, Thuwal (SA); Santiago ARANGO, Thuwal (SA)

(21) Appl. No.: 15/512,670

(22) PCT Filed: Sep. 28, 2015
(86) PCT No.: PCT/IB2015/002298

§ 371 Date: Mar. 20, 2017

Related U.S. Application Data
(60) Provisional application No. 62/071,704, filed on Sep. 30, 2014.

(51) Int. Cl. G01V 3/02; G01V 99/00; G06F 17/50; G01V 3/36; G06F 17/16

(52) U.S. Cl. CPC G01V 3/02; G01V 99/005; G06F 17/16; G01V 3/36; G06F 17/5009

(57) ABSTRACT

Systems and methods for reservoir resistivity characterization are provided. In various aspects, an integrated framework for the estimation of Archie's parameters for a strongly heterogeneous reservoir utilizing the dynamics of the reservoir are provided. The framework can encompass a Bayesian estimation/inversion method for estimating the reservoir parameters, integrating production and time lapse formation conductivity data to achieve a better understanding of the subsurface rock conductivity properties and hence improve water saturation imaging.

### CROSS-REFERENCE TO RELATED APPLICATION

This application claims the benefit of and priority to U.S. Provisional Application Ser. No. 62/071,704, having the title “RESERVOIR RESISTIVITY CHARACTERIZATION INCORPORATING FLOW DYNAMICS,” filed on Sep. 30, 2014, the disclosure of which is incorporated herein in by reference in its entirety.

### TECHNICAL HELD

The present disclosure generally relates to techniques for characterization of a reservoir, in particular reservoir resistivity characterization.

### BACKGROUND

Electromagnetic techniques have found widespread application for reservoir characterization and imaging in recent decades. Technological advances have led to the ability to accurately track water fronts and displaced hydrocarbon bearing spots. Although significant improvements have been achieved in the inversion of electromagnetic techniques, making them applicable in a variety of different environments, relating them to reservoir flow properties has continued to be challenging. Archie's Law has been the standard model in relating conductivity to water saturation and formation porosity. Studies have shown, however, that Archie's exponents vary within the reservoir and undergo strong uncertainty resulting in inaccurate calibration of Archie's relationship.

### SUMMARY

The present disclosure tackles the problem of accurate calibration of Archie's relationship and therefore enables a more precise determination of the water saturation distribution in the reservoir. The disclosure, in particular, provides an improved characterization of the reservoir and can achieve significantly greater improvements in the characterization of the reservoir. In one or more aspects the improved characterization is achieved via linking the parameter estimates to resistivity logs at the wells.

In various aspects, a new reservoir history matching framework is provided. Based on a Bayesian estimation/inversion technique, such as an ensemble Kalman filter or smoother, we have synergized the correlation of Archie's exponents with the subsurface reservoir dynamics in order to estimate these exponents and hence improve the water saturation to conductivity relationship. Utilizing reservoir production data and conductivity maps from EM imaging, the present estimation of the exponents of Archie's Law can yield a better interpretation of the reservoir formation and the detection of reservoir water flooded areas while simultaneously quantifying the uncertainty in the parameters.

Disclosed are various embodiments for reservoir resistivity characterization. In an embodiment a method is provided for characterizing a reservoir. In various aspects the method is a computer implemented method that can include the steps of: executing, by a computing device, a reservoir simulator based at least in part on a geological model; generating, by the computing device, observational data sets based at least in part on a current reservoir simulator state by querying an observation module the observational data sets being stored in memory; generating, by the computing device, a forecasted reservoir dynamics state over a period of time (such as by applying history matching) to at least the current reservoir simulator state and the observational data; determining, by the computing device, a conductivity distribution of the field of the reservoir based on the forecasted reservoir dynamics; recording, by the computing device, production data of the reservoir; and updating, by the computing device, the current reservoir state including updating one or more reservoir parameters in the reservoir simulator based on the determined conductivity distribution and the recorded production data. The steps can be repeated until a termination criteria is met.

In an embodiment a system is provided for characterizing a reservoir. In various aspects the system can include: at least one computing device comprising a processor and a memory; and program instructions that, when executed, cause the at least one computing device to: initialize a reservoir simulator based at least in part on a geological model; generate observational data sets based at least in part on a current state of the reservoir simulator by querying an observation module; generate a forecasted reservoir dynamics state over a period of time (such as by applying history matching) to at least the current reservoir simulator state and the observational data; determine a conductivity distribution of the field of the reservoir based on the forecasted reservoir dynamics; record production data of the reservoir; and update the current reservoir state including update of one or more reservoir parameters based on the determined conductivity distribution and the recorded production data. The system can be configured to repeat the generating the observational data sets, the simulating the forecasted reservoir dynamics state, determining the conductivity distribution, recording production data, and the updating the current reservoir simulator state until a termination criteria is met.

In any one or more aspects of the method or the system, the history matching can comprise a Bayesian estimation technique. The Bayesian estimation technique can comprise a Bayesian filtering, smoothing or direct inversion method. The Bayesian estimation technique can comprise an Ensemble Kalman Filter technique. The geological model can define at least one of a geological structure, a number of wells, a pressure, a saturation, a permeability, or a porosity. The one or more reservoir parameters can include one or more Archie's Law parameters. The observation module can be an electromagnetic (EM) survey module configured to calculate a time lapse conductivity response based at least in part on a porosity data and a salt concentration data, and wherein one of the at least two observational data sets comprises the time lapse conductivity response. The one or more reservoir parameters can be estimated by assembling the data, integrating the ensemble forward in time to forecast the ensemble, determining moments of a state vector of the forecasted ensemble, and updating the forecasted ensemble with at least some of the production data. The updated one or more parameters can be returned to the reservoir simulator. The reservoir simulator can generate a graphical user interface for rendering a display device and the updating of the reservoir parameters can cause an updating of the graphical user interface.

Other systems, methods, features, and advantages of the present disclosure for reservoir resistivity characterization will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the present disclosure can be better understood with reference to the following drawings. The components in the drawings are not necessarily to scale, emphasis instead being placed upon clearly illustrating the principles of the present disclosure. Moreover, in the drawings like reference numerals designate corresponding parts throughout the several views.

FIG. 1 depicts a graphical illustration of water saturation dependence on rock conductivity as given by Archie's Law.

FIG. 2A is a flowchart illustrating an example of an Archie parameter estimation framework according to various embodiments of the present disclosure.

FIG. 2B is a flow chart illustrating an example of an Archie parameter estimation framework executed in a computing environment according to various embodiments of the present disclosure

FIG. 3 depicts a domain representation of a modeled reservoir including well locations.

FIG. 4 is a depiction of a true permeability field of Kzz of the domain.

FIG. 5 is a depiction of a true porosity distribution of the domain, the domain exhibiting strong heterogeneity in the porosity values.

FIG. 6 depicts an oil-water relative permeability.

FIG. 7 depicts an exemplary saturation distribution in 2006, 2011, 2016 and 2021.

FIG. 8 is an example of the spatial distribution of porosity exponent n for a number of ensembles.

FIG. 9 presents exemplary ensemble History Matching results comparing forecasted (right) and history matched (left) results. Time in days shown along the x-axes.

FIG. 10 presents exemplary ensemble History Matching results for the field production rates for unmatched (right) and history matched (left) data. Time in days shown along the x-axes.

FIG. 11 depicts water saturation streamlines for different time spans.

FIG. 12 is a scatter plot comparing true saturation exponent to estimated water saturation exponent, m. (blue=initial estimate, red=final estimate).

FIG. 13 is a scatter plot comparing true cementation exponent to estimated cementation exponent. n. (blue=initial estimate, red=final estimate).

FIG. 14 depicts a comparison of the saturation exponent, m, distributions for the true, initial estimate and final estimate.

### DETAILED DESCRIPTION

Described below are various embodiments of the present systems and methods for reservoir resistivity characterization. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

### I. INTRODUCTION

The earth's composition encompasses a tremendous amount of different materials and elements that show varying degrees of the ability to conduct electricity. Exploiting the conductivity contrast between different elements and rocks has led to the development of significant industries such as the electronic industry. Hydrocarbons are typically found in sedimentary rock structures that exhibit in dry form poor conductivity. Their conductivity may change significantly, however, when being subjected to water. Water conductivity may differ significantly but display a strong dependence on both temperature and salt concentration. Higher salt concentrations typically lead to strong conductance of electricity being caused by the high prevalence of sodium chloride ions in the water.

This relation is also encountered in water saturated rocks that exhibit a positive correlation between higher saturation levels and higher electric conductance. While typically higher water saturation levels lead to increased conductivity, the dependence and correlation may significantly differ for different rock types. Igneous rocks although varying considerably in porosity, display rather poor conductivity as compared to metamorphic and sedimentary rock types, but even amongst sedimentary rocks such as limestone, sandstone and shale electrical properties and its dependence on water saturation and porosity may deviate.

With the invention of the electrical resistivity tools in the early 20^{th} century by the brothers Schlumberger, resistivity logging has gained significant attraction for determining hydrocarbon reservoirs, water saturation levels and porosity of the formation. Electrical resistivity logging gained prominence and more widespread application with the influential paper by G. Archie in 1942 (G. E. Archie, 1942). In his works (G. E. Archie, 1950; G. Archie, 1952; G. E. Archie, 1942; Gustave Erdman Archie, 1947), Archie investigated the electrical conductivity of different rock types with respect to saturation and porosity levels. The conclusion drawn from the experiments indicated that the conductivity of the different rock types may behave as being in log form the sum of the weighted components of porosity and water saturation. More explicitly the conductivity of the rock is given by

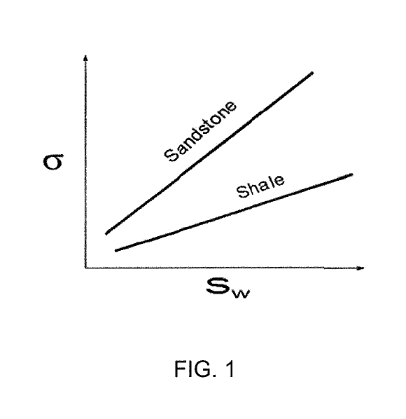

log(σ)=C_{w}+n log(ϕ)+m log(S_{w}) (0)

where σ is the rock conductivity, ϕ the rock porosity, S_{w} the water saturation, C_{w} a constant depending on the conductivity of the water, and m and n are fitted parameters typically retrieved from a regression analysis. The parameter m is also called the water saturation exponent, and the parameter n is known as the cementation or porosity exponent. We outline in FIG. 1 an example of the conductivity relationship for increased water saturation for two different rock types (Mavko, Mukerji, & Dvorkin, 2009). Shale formations as encountered for hydraulic fracturing typically exhibit low porosity and weak dependence for rising water saturation as compared to sandstone formation that are generally more porous and conductive.

While the general log relationship may hold true for general rock types, the parameters n and m in Archie's Law may differ strongly between different rock types but also may vary within the reservoir formation. In particular the dependence on the formation factor has been subject to extensive research. Significant amounts of research (Carothers, 1968; Hill & Milburn, 2003; J. Glover, 2010; Nikravesh & Aminzadeh, 2001; Tixier & Alger, 1970; Winsauer, 1952) went into understanding the dependence of Archie's parameters that led, however, to the conclusion that the parameters may significantly vary for different formations and rock types and hence need to be calibrated or estimated.

Conventionally resistivity logging tools and core samples are employed to determine saturation and porosity levels and infer from joint calibration with other data the Archie parameters. While this typically provides a good representation of the rock-conductivity relationship, it may considerably misrepresent the areas farther away from the wells.

Amongst the most recent papers, Hamada et al. (AL-Awad, 2001; G. Hamada & Almajed, 2013; G. M. Hamada, 2010) presented a laboratory study for retrieving Archie's parameters and their uncertainty on 29 natural carbonate reservoir core plugs at reservoir conditions, Initial studies conducted by the authors have shown that Archie's parameters have the strongest influence on calculating the water saturation and initial oil in place from the retrieved resistivity parameters. Using three different techniques, conventional Archie parameter techniques, core Archie's parameter estimate technique and three-dimensional technique, the obtained profiles exhibited significantly differing water saturation values that were attributed to the uncertainty levels in the determination of Archie's parameters.

Talabani et al. (Talabani, Boyd, Wazeer, & Arfi, 2000) investigated the validity of Archie's equation for carbonate rock formations and concluded that the parameter called cementation factor n in Archie's equation is influenced by multiple factors and may differ significantly for complex pore systems, They also concluded that the relationship between water saturation and resistivity may be strongly nonlinear and that the hydrocarbon-water fluid critical point may necessitate further studies concerning its influence on the electrical properties of the media.

Maute (haute, Lyle, & Sprunt, 1992) outlined a data-analysis method for obtaining optimal Archie parameters with reduced uncertainty for the general formation and exhibited the challenges and variation in the parameters for a general rock reservoir formation. The effect of the uncertainties in the rock-conductivity parameters m and n was addressed by Moore (William R. Moore, 2011) wherein the authors outlined approaches to take into account the propagated uncertainties and its importance in properly analyzing the petrophysical properties of the underlying rock formation.

While Archie's Law has been one of the most general to determine the saturation and porosity levels from the resistivity response of the formation, there have been advances in improving the accuracy of the model for other rock formations, amongst others, for shaly-sand rock. This has led to the development of the Waxman-Smits-Thomas equation (Waxman & Smits. 2003) and Poupon's equation (Leveaux & Poupon, 1971; Poupon & Leveaux, 1971). The Waxman-Smits-Thomas equation (Jin, Torres-Verdin, & Devarajan, 2007; Revil & Glover, 1998) was proposed by Waxman and Smits (Waxman & Smits, 2003) to describe the dependence of shaly-sand conductivity on clay-content, which was expressed as the cation exchange capacity per unit pore volume. The model has become one of the standard based approaches for understanding the electrical conductivity of shaly-sand formations (Bussian, 1983) and is given by

$$σ = \frac{1}{{F}_{R}} ( {σ}_{w} + {σ}_{d} ) \qquad ( 2 )$$

where F_{g} is the formation shaly-sand resistivity formation factor, typically obtained for measurements at high salinity where the electrical surface conductivity is neglected, σ_{w} is the water conductivity and σ_{cl} the conductivity of the HCM exchange. The clay conductivity

σ_{cl}=v_{mb}V_{c} (3)

is the product of the average mobility v_{mb} of the hydrated clay minerals (hcm) counter-ions and V_{c} the volume concentration of the hcm exchange cations.

Shang et. al. (Shang, Hamman, & Caldwell, 2004) developed an equivalent rock model for the estimation of water saturation levels within the reservoir and showed improvement in the resistivity estimates for rock types that do not follow Arches Law. The number of parameters that need to be estimated and the limited laboratory analysis may, however, not be sufficient to determine general validity of the method.

Although several models for relating conductivity of the rock formations to water saturation and porosity have been proposed (Bussian, 1983; Chen & Dickens, 2009; Jin et al., 2007; Leveaux & Poupon, 1971; Poupon & Leveaux, 1971), none of them has been able to represent various rock formations in a reservoir and all have exhibited high uncertainties in their model parameters (G. M. Hamada, 2010). This has outlined the importance of estimating the parameters for different sections of the reservoir to deliver more accurate resistivity-saturation relationships.

We have developed an integrated framework for the estimation of Archie's parameters for a strongly heterogeneous reservoir utilizing the dynamics of the reservoir. The framework encompasses a Bayesian estimation/inversion method for estimating the reservoir parameters, integrating production and time lapse formation conductivity data to achieve a better understanding of the subsurface rock conductivity properties and hence improve water saturation imaging.

### II. FRAMEWORK

Estimating Archie's parameters is typically based on laboratory tests using regression analysis on Equation (2). While providing a detailed understanding of the rocks close to the wellbore, it may misrepresent rock factors in other segments of the reservoir. The presented framework is intended to overcome these challenges via estimating the Archie's parameters together with other reservoir parameters (such as water saturation, porosity, permeability, etc.) using reservoir flow dynamics. For estimation of the flow dynamics we can use an ensemble based filter, such as an ensemble-based Kalman filter, to simultaneously provide a quantification of the uncertainty in the parameters. One skilled in the art will recognize, however, that other ensemble based filters or smoothers such as a Singular evolutive interpolated Ensemble Kalman Filter technique can be used.

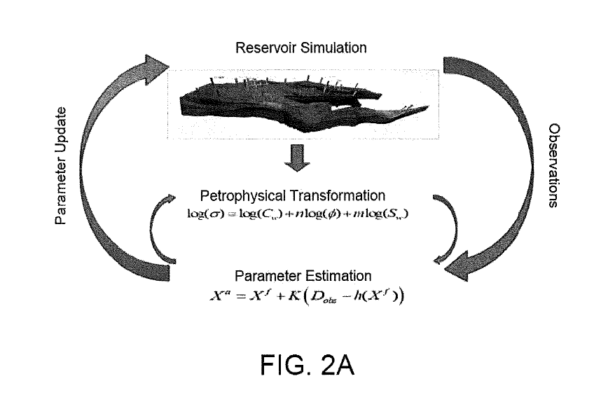

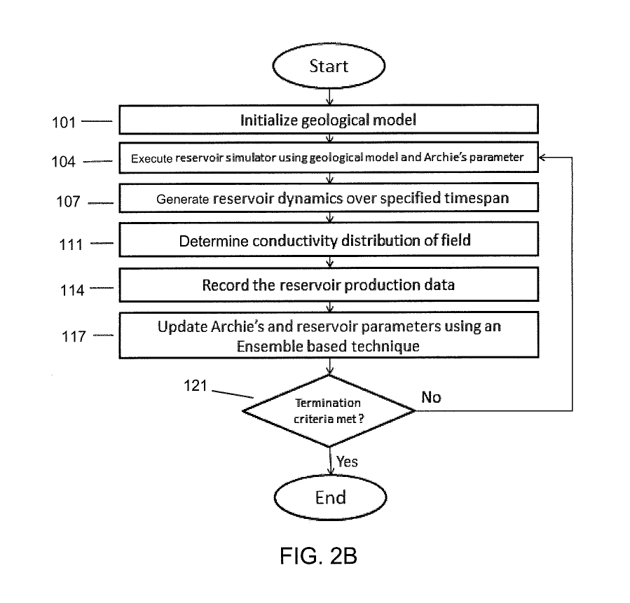

An embodiment of the framework of the present disclosure is depicted in FIG. 2A. The system and method interfaces a reservoir simulator to the estimation framework and utilizes the well observations and conductivity attributes for updating the Archie's parameters n and m (Eq. 1) sequentially in time for the individual cells. Suitable reservoir simulators include any commercial or non-commercial reservoir simulator. The sequential estimation and the utilization of the reservoir flows prove beneficial in the estimation of the parameters using the correlation to the water saturation and other well parameters, such as water saturation and porosity. Starting out with an initial ensemble consisting of heterogeneous permeability, porosity and the Archie conductivity parameters (n and m), the individual ensemble members are forward integrated in time, and subsequently updated via the Bayes' rule. The updated parameters are returned to the reservoir simulator for the next time step. The forward integration, or modeling, in time allows us to integrate the flow dynamics of the reservoir over time to better estimate the parameters n and m. For example, water saturation in the reservoir can change over time. This forward modeling allows such change to be applied to the estimation.

In various embodiments, a reservoir resistivity characterization application of the present disclosure can be executed in a computing environment that may comprise, for example, a computing device such as a server computer or any other system providing computing capability. Alternatively, the computing environment may employ a plurality of computing devices that may be arranged, for example, in one or more server banks or computer banks or other arrangements. Such computing devices may be located in a single installation or may be distributed among many different geographical locations. For example, the computing environment may include a plurality of computing devices that together may comprise a hosted computing resource, a grid computing resource and/or any other distributed computing arrangement. In some cases, the computing environment may correspond to an elastic computing resource where the allotted capacity of processing, network, storage, or other computing-related resources may vary over time.

The reservoir resistivity characterization application is executed to provide state and parameter estimation (including forward modeling) over time of a reservoir such as a gas reservoir, oil reservoir, water reservoir, or other reservoir. To this end, the reservoir resistivity characterization application may implement or otherwise simulate a geological model corresponding to a reservoir to be forecasted. The geological model may encode physical or geological attributes corresponding to a reservoir. These physical or geological attributes may include, for example, a geological structure, a number of wells, pressure, saturation, permeability, porosity, or other attributes.

The reservoir resistivity characterization application may also implement or execute a reservoir simulator based on the attributes encoded in the geological model and also based on Archie's parameters, n and m. The reservoir simulator may be implemented using a MATLAB reservoir simulator toolbox (MRST), or other tool sets, libraries, or other functionality as can be appreciated. For example, the reservoir simulator may include a 2D or 3D finite difference black oil simulator MRST implementing a two-phase flow problem for the oil and water phase of a reservoir. The reservoir simulator can be used to simulate predicted reservoir dynamics, such as reservoir flow dynamics, over a specified timespan. An important aspect is the modeling of the salt concentration within the reservoir that is achieved via coupling the reservoir simulation to a salt transport model. The specified timespan can be an arbitrary timespan, such as three years in the future though the future timespan can be more or less than three years. For example, the reservoir simulator may calculate predicted transformations to various attributes of the geological model over time. To this end, the geological model may comprise an initial state for the reservoir resistivity characterization application to transform based at least in part on data generated by observation modules and a history matching and forecasting module, as will be described below. The reservoir simulator may also be implemented by another approach.

The reservoir resistivity characterization application may provide output generated by the execution of the reservoir simulator to an observation module to generate various data sets to be provided to a history matching and forecasting module as will be described. The observation module may include, for example, an electromagnetic (EM) survey module, or other observation modules.

The observation module is executed to determine the resistivity response or formation conductivity of a reservoir formation. This may include, for example, performing one or more transformations to porosity data, water saturation data, salt (brine) concentration data, or other data to formation resistivity or conductivity. The formation conductivity may be expressed as a function of a discrete state or over time. One or more conductivity distributions of the reservoir field can be calculated for a given time or for a number of different times over a time period. Such transformations may be implemented according to Archie's Law, variants thereof, or other algorithms or approaches. Such transformations may be implemented to estimate one or more reservoir parameters including one or more of Archie's parameters. Production data for the reservoir can be recorded for a given time period or for given time periods. The formation conductivity and reservoir production data or history may then be provided to a history matching and forecasting module.

The history matching and forecasting module can generate a forecasted reservoir state based on a given reservoir state provided by the reservoir simulator, as well as data generated by the observation module such as the conductivity distribution data and the reservoir production data. For example, the history matching and forecasting module can produce one or more estimations of Archie's parameters. The history matching and forecasting module may apply a Bayesian filtering or smoothing or inversion technique, such as an Ensemble Kalman Filter (EnKF), to this data to generate the forecasted reservoir state including the one or more estimates of Archie's parameters. The forecasted reservoir state can then be provided to the reservoir simulator. The data, including the parameter estimations, can then be applied by the simulator to update Archie's and reservoir parameters in the reservoir model. The reservoir simulator may then perform with the forecasted reservoir state as an initial state. To this end, the reservoir simulator, observation modules, and history matching and forecasting module may provide data to each other cyclically to forecast or forward model reservoir states over time including the parameter estimation(s). The process can be repeated to provide continuous estimation of Archie's and the reservoir parameters and updating of the reservoir model.

Various applications and/or other functionality may be executed in the computing environment according to various embodiments. Also, various data may be stored in a data store that is accessible to the computing environment. The data store may be representative of a plurality of data stores as can be appreciated. The data stored in the data, for example, is associated with the operation of the various applications and/or functional entities described below.

Referring next to FIG. 2B, shown is a flowchart that provides one example of the operation of a portion of the reservoir resistivity characterization application according to various embodiments. It is understood that the flowchart of FIG. 2B provides merely an example of the many different types of functional arrangements that may be employed to implement the operation of the portion of the reservoir forecasting application as described herein. As an alternative, the flowchart of FIG. 2B may be viewed as depicting an example of elements of a method implemented in a computing environment according to one or more embodiments.

Beginning with box 101, the reservoir forecasting application generates a geological model. This may include, for example, loading a predefined geological model from a data store, initializing a new geological model by defining one or more geological model attributes, or another approach. As a non-limiting example, geological model attributes may include a geological structure. The geological structure may include one or more of fault layers, rock formation fluid type, etc. The geological model may also specify the well information, including for example a number of wells. The geological model may also include initially assumed parameters, such as pressure, water saturation, permeability, porosity, or other attributes of a reservoir to be provided to a reservoir simulator.

Next, in item 104, the attributes or parameters are transferred to a reservoir simulator and the reservoir forecasting application initializes the reservoir simulator using the geological model. This may include defining or initializing one or more data parameters, including Archie's parameters, of the reservoir simulator as a function of corresponding attributes encoded in the geological model. Initializing the reservoir simulator may include executing or initializing a process or application corresponding to the reservoir simulator in a computing environment distinct from the reservoir forecasting application. In such an embodiment, the reservoir forecasting application may be configured to communicate with or provide data to the separate reservoir simulator application. In other embodiments, the reservoir simulator may be initialized as functionality encapsulated within the reservoir forecasting application. The reservoir forecasting application may also be initialized by another approach.

Moving on to box 107, the reservoir forecasting application generates simulated reservoir dynamics, oil, water and gas transport as well as the salt concentration, over a specified timespan. The timespan can be any given timespan. A typical timespan can be any given number of years, such 2-20 years, preferably 2 to 15 years.

In box 111, the reservoir forecasting application determines (for example calculates) a time lapse conductivity response via an observation module, such as an EM survey module. This may include calculating one or more conductivity distributions of the reservoir field by applying Archie's Law, variants thereof, or other approaches, to porosity, water saturation and salt concentration data embodied in the geological model, obtained from the reservoir simulator, or otherwise accessible to the observation module. The conductivity distribution(s) may also be calculated with respect to a previously sampled conductivity to calculate the time lapse conductivity response. The time lapse conductivity response may also be calculated by another approach. Next, in box 114, the reservoir forecasting application records production data for the given reservoir. This production data may include well data such as bottom hole, pressure, water cut, well gas production, well oil production and other data. The data can be data representing selected times or data over a given timespan. The timespan can be over 2 to 30 years.

The reservoir forecasting application then, in box 117, invokes the history matching and forecasting module to perform history matching on various data parameters. Such data parameters may include, for example, those data parameters obtained by simulation, calculation or recordation in boxes 104-114, data embodied in the geological model, attributes or other data points calculated or generated by the reservoir simulator, or other data. Performing history matching may include calculating updated parameters for the reservoir simulator based on the data operated upon by the history matching and forecasting module. For example, performing the history matching may include calculating updated reservoir parameters, such as permeability data, porosity data, pressure data, waters saturation data, or other data as can be appreciated. This can include, in particular calculating updated Archie's parameters to provide an estimation of Archie's parameters. The updated parameters, for example updated Archie's and reservoir parameters, may be calculated by applying a Bayesian filtering, smoothing or inversion technique, such as an Ensemble Kalman Filter or a smoother, or even a direct Bayesian inversion approach.

The reservoir forecasting application updates the reservoir simulator state based on the updated parameters generated in box 117. This may include, for example, redefining or re-instantiating parameterized data of the reservoir simulator according to the updated parameters. This may also include invoking or performing one or more operations of the reservoir simulator to generate the updated state. After updating the reservoir simulator state, in box 121, the reservoir forecasting application determines if a termination criteria has been met. As a non-limiting example, termination criteria may include a number of iterative steps performed by the reservoir forecasting application meeting or exceeding a threshold, a passage of a predefined interval, a forecasting state corresponding to a time period meeting or exceeding a threshold, or other criteria. If a termination state has not been met, the process returns to box 104. Otherwise, the process ends.

### II.1 Geological Formation & Reservoir Simulation

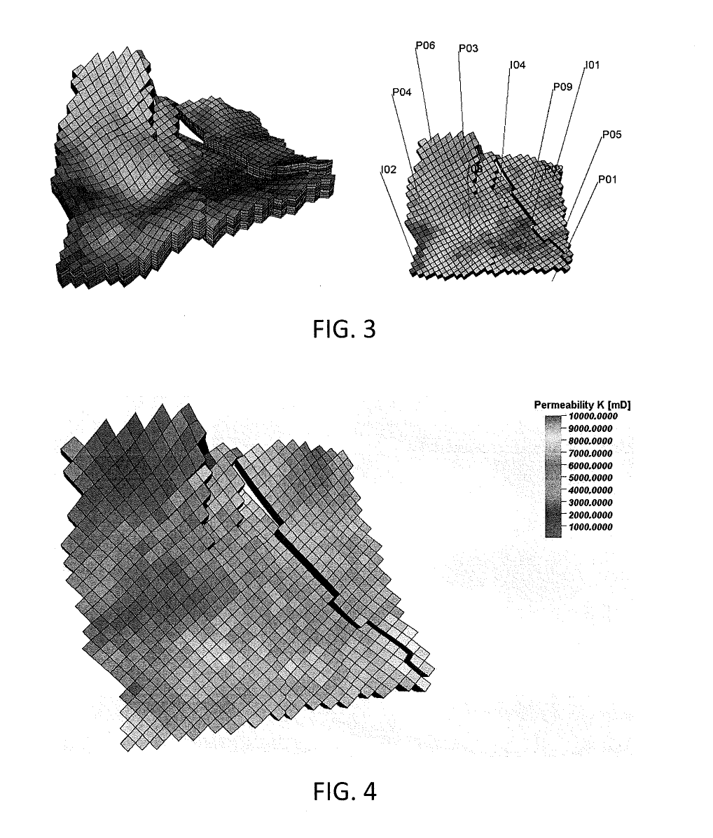

We now provide an exemplary application of the above framework in the context of a modeled reservoir. The modeled reservoir simply provides one example of any number of reservoir conditions that may be found and applied. The modeled reservoir is displayed in FIG. 3 and represents a subpart of the Abqaiq oilfield. The reservoir encompasses five fault lines that divide the reservoir into six segments and has four vertical injector wells and six producing wells that are represented in FIG. 3. The reservoir is 9 km wide in length and 10 km in width and exhibits a total depth of 2.8 km. All wells are steel cased and perforated with a plugback installed below the casing. The Eclipse reservoir simulator modeling the three-phase flow of gas, oil and water within the reservoir was utilized as a forward model (GeoQuest, 2010) incorporating the transport of the salt concentration within the water phase. Other reservoir simulator modeling can be used, however, such as any commercial or non-commercial reservoir simulator.

### II.2 Rock Conductivity Model

Archie's relationship is given in the standard form by

σ=C_{w}ϕⁿS_{w}^{m} (4)

where n represents the cementation factor exponent and m the water saturation exponent. For purposes herein the exponents, n and m, are referred to interchangeably with the above described parameters n and m and are called herein “Archie's parameters.” The conductivity of the reservoir brine was computed from (Dresser, 1982)

$${C}_{w} = {[ ( 123 \times {10}^{- 4} + \frac{36475}{10 {c}_{s}^{0.955}} ) \frac{82}{1.8 T + 39} ]}^{- 1} . \qquad ( 5 )$$

with cₛ denoting the salt content in ppm and T the temperature in Celsius. For conventional reservoirs the salt content is around 30,000-300,000 ppm and the temperature ranges from 80 to 110 celsius.

### II.3 EnKF

For the state parameter estimation framework for estimating the parameters or exponents, n and m, we have utilized the Ensemble Kalman Filter. The state-space formulation for the subsurface parameters, such as permeability, porosity and Archie's exponents, is given by the system

zₖ₊₁= [symbol] (zₖ,θₖ)+ηₖ (6)

yₖ=h(xₖ)+ϵₖ (7)

Where xₖ=[zₖ,θₖ] is the state vector to be estimated at the k-th update step, yₖ the observation vector and η and ϵ are the zero mean white noises whose covariance matrices are given by B and R.

The EnKF was first introduced by Evensen et. al. (Evensen, 1994), and has been ever since extensively applied in the field of reservoir history matching (Aanonsen, Oliver, Reynolds, & Vall, 2009). The EnKF differs from the Kalman Filter in that the distribution of the system state is represented by a collection, or ensemble, of state vectors approximating the covariance matrix of the state estimate by a sample covariance matrix computed from the ensemble. Despite the fact that the EnKF updates are based on a second order statistics (i.e. only means and covariances neglecting higher order moments of the joint probability density distribution of the model variables) and that these covariances are computed from a finite size ensemble, the EnKF has shown to work remarkably and efficiently well for a variety of problems compared to other history matching optimization algorithms (Aanonsen et al., 2009).

In order to achieve efficient computation and to handle the nonlinear observations, we have implemented an observation matrix-free implementation of the EnKF. Let Nₑ be the ensemble size and Xₖ=[x_{i,k}, . . . , x_{N}_{ₑ}_{,k}] the state ensemble matrix at the k-th iteration step, with x_{i,k} denoting the state vector of the i-th ensemble member at the k-th time step. The EnKF operates in two steps. The Forecast step integrates the ensemble forward in time to compute the first two moments, i.e., mean and covariance, from the sample mean and covariance of the forecast ensemble. The Analysis step updates the forecasted ensembles with incoming data (such as well observation data and reservoir conductivity distribution from EM inverted data) before proceeding to a new forecast cycle. More explicitly, define the scaled covariance anomaly

$${A}_{k} = {X}_{k} - \frac{1}{{N}_{e}} ( {\sum }_{i = 1}^{{N}_{e}} {x}_{i , k} ) {e}_{1 \times {N}_{e}} \qquad ( 8 )$$

with e_{1×N}_{ₑ} denoting the matrix with ones as elements and size 1×Nₑ, and

$${[ {H}_{k} ]}_{: , j} = {h}_{k} ( {x}_{i , k} ) - \frac{1}{{N}_{e}} {\sum }_{j = 1}^{{N}_{e}} {h}_{k} ( {x}_{j , k} ) \qquad ( 9 )$$

the matrix observation matrix with hₖ(x_{i,k}) being the nonlinear observation for the i-th ensemble state vector x_{i,k}. Then for the data matrix Dₖ, with the columns containing the observation perturbed with noise sampled from the observational error covariance matrix Rₖ, the EnKF update step can be written as:

$${X}_{k}^{a} = {X}_{k}^{f} + \frac{1}{{N}_{e} - 1} {A}_{k} {{H}_{k}^{T} ( \frac{1}{{N}_{e} - 1} {H}_{k} {H}_{k}^{T} + {R}_{k} )}^{- 1} ( {D}_{k} - {h}_{k} ( {X}_{k}^{f} ) ) \qquad ( 10 )$$

with Xₖ^{f} being the forecasted ensemble state obtained by integrating each ensemble member in time with the reservoir simulator [32]. The EnKF therefore updates each ensemble independently in such a way that the resulting sample mean and covariance of the updated ensemble (asymptotically) matches the Kalman filter analysis and associated error covariance. This requires perturbing the data before updating each ensemble member [32], forming the matrix D as defined above. For further details about the EnKF, the reader may refer to the review articles of Aanonsen et, al. (Aanonsen et al., 2009) and Luo et. al. (Luo & Hoteit, 2013).

### III. SIMULATION RESULTS

The forthcoming section provides an analysis of the performance of the reservoir characterization estimation framework, investigating both the history matching performance as well as the quality of the conductivity estimates, including the estimation of Archie's parameters. We provide first an outline of the experimental setup, then analyze the rock conductivity parameters and investigate its differences, followed by history matching results outlining the water front tracking capabilities.

### III.1 Experimental Setup

The reservoir structure represents a highly heterogeneous formation. The permeability tensor was assumed to be diagonal with different Kₓₓ, K_{yy} and K_{zz} field distributions. Permeability values ranged from from 1 md to 9,175 md. The permeability distribution was obtained from an exponential variogram model computed in Petrel. The reference permeability field for K_{zz} is represented in FIG. 4.

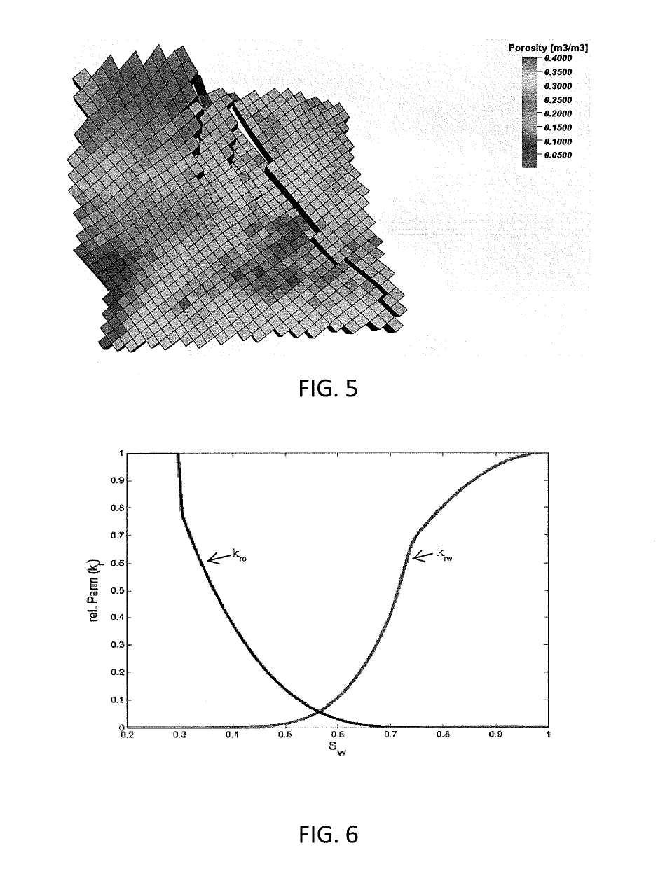

Strong heterogeneity is also encountered for the porosity domain where the fields were obtained using an exponential variogram model ranging from 0.5% to 29.94%. The true porosity field is represented in FIG. 5 illustrating the strong heterogeneity in the porosity. All producer wells were operated and water was injected simultaneously into all wells. For the development of the field we have utilized a group production strategy injecting 100,000 sm³/d of water. The water injection, however, can be more or less, Reservoir temperature was assumed to be at 87.3° C., and natural formation pressure was set to 215 bar. The salinity of the brine was kept at 30,000 ppm throughout the simulation.

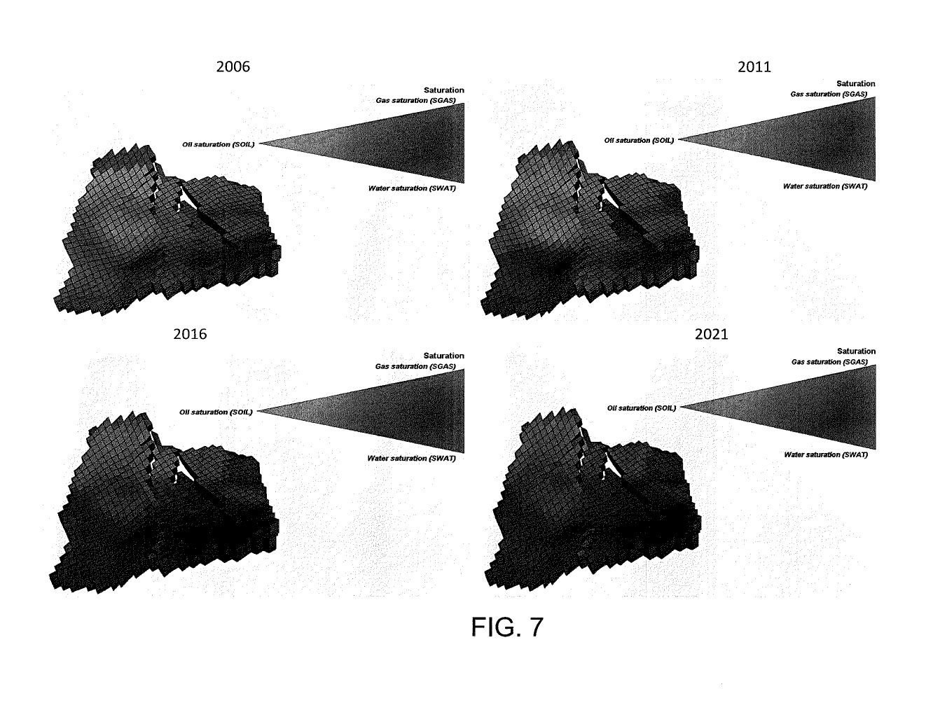

We present further in FIG. 6 the relative permeability curves for oil-water where a residual water saturation of 30% was assumed that is in agreement with the experimental results obtained from the reservoir.

Total simulation time was assumed to be 15 years consisting of 10 years of history matching and 5 years of forecasting. The phase evolution is outline in FIG. 7. It should be understood, however, that other simulation time periods and/or periods of history can be used. For example we may use 12, 10, 8, 6, 4, 3, or 2 years of total simulation time, or more or less, or any time in between.

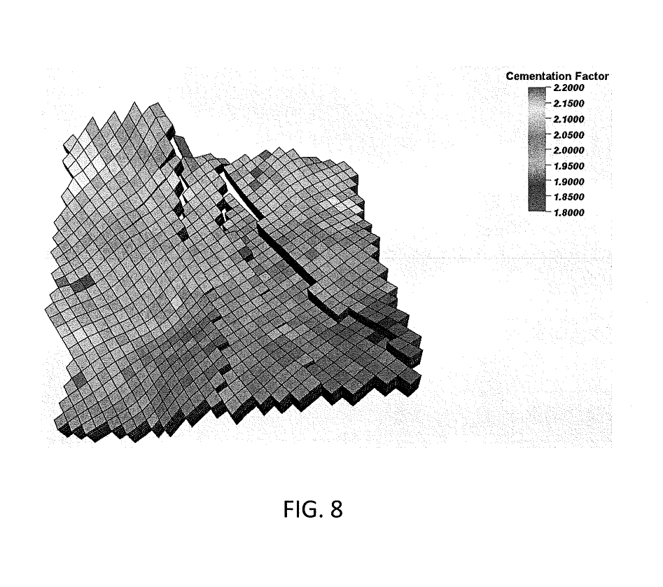

In total 55 ensemble members were generated that differ in permeability, porosity and Archie's parameters. The number of ensemble members, however, can be more or less than 55. The cementation exponent n and water saturation exponent m were obtained via perturbation of the data by the addition of Gaussian noise to the true distribution. Gaussian noise is not the only way to obtain the distribution. We present in FIG. 8 an example of the initial spatial distribution of the water saturation exponent m for the ensembles. The distribution clearly outlines the heterogeneity of the parameters.

### III.2 History Matching

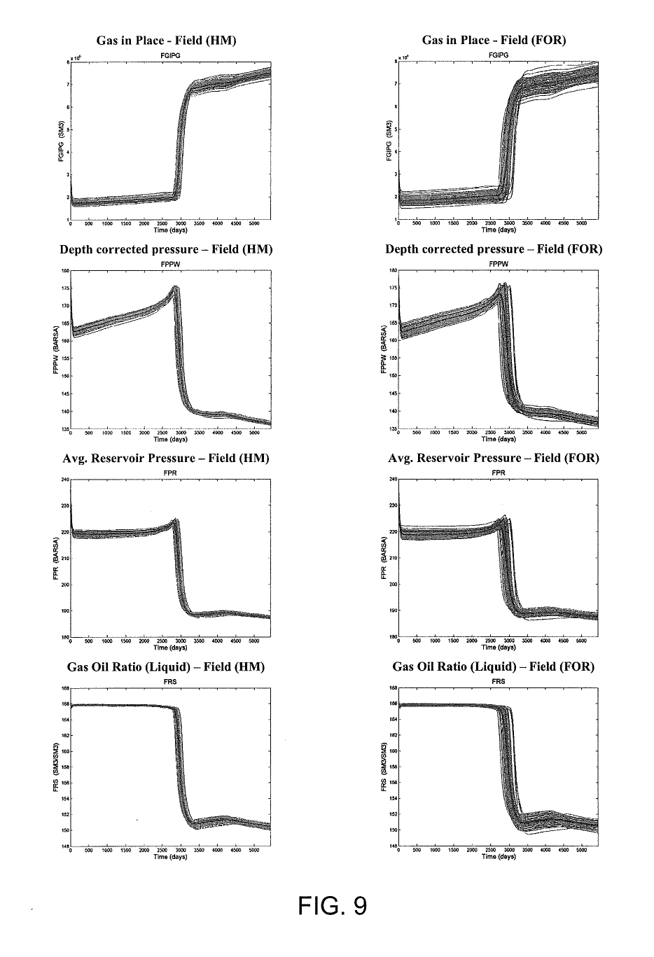

We present below an analysis of the quality of the reservoir history matches and the estimation of the reservoir parameters, We present in FIG. 9 examples of the history matches using the EnKF versus ensemble forecasting. A comparison of the solutions of the ensemble members when no history matching is applied clearly outlines the considerable uncertainty in the field production. For the gas in place in the field we observe a strong upshot from around 2 MM sm3 to around 6.6 MM sm3 that is caused by high water saturation. This effect is also observed in the FRS ratio that shows the significant drop in the Oil to Gas ratio in liquid phase relating inversely to the upward dynamics in the gas in place.

We further analyze the water potential and average pressure level within the reservoir. The water potential (depth corrected pressure) is the pressure that is acting on the injected water if depth effects are extracted and is an important indicator about the pressure that is applied on the surface. Knowing the water potential assists in adjusting the pressure levels of the injected water to ensure optimal sweep efficiency upon injection and avoid any blow out or excessive pressure application that may damage the well and perforation. The pressure drop is primarily induced by reaching a certain water saturation level such that the relative permeability of the oil phase is effectively zero leading to these changes.

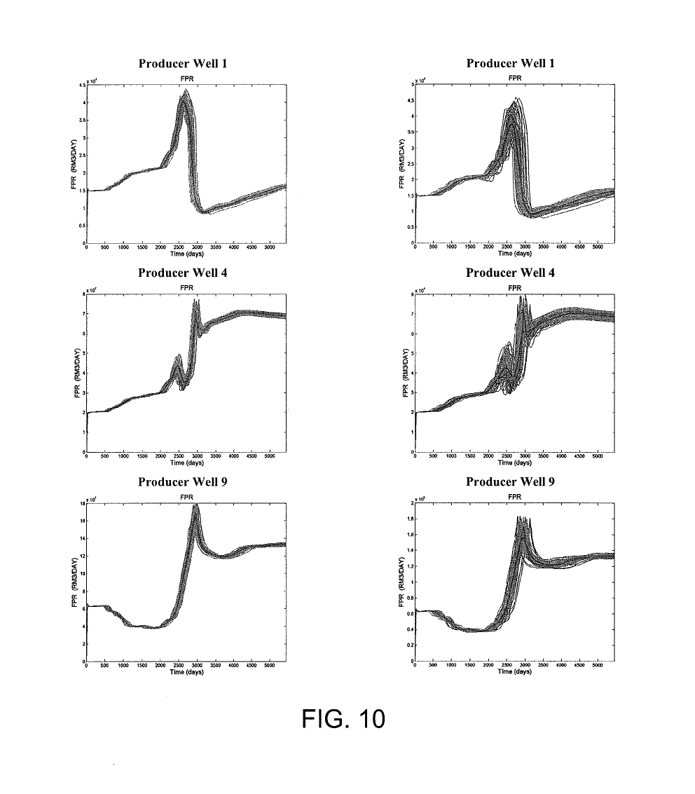

Presented in FIG. 10 is a comparison of the field production rates for different producing wells. Production from the wells starts from the beginning leading to a gradual rise in the production levels for the 1st and 4th producing well while the production level for the 9th well decreases. After around 7 years the gradual propagation of the water displaces a considerable amount of oil towards the producing well that leads to a sharp rise in production, and a subsequent sharp drop in particular for the first producing well. This sharp drop for the first producing well is caused by the upward propagation of the reservoirs' natural gas that is a consequence of the pressure drop and increase in the gas-to-oil ratio observed in FIG. 9.

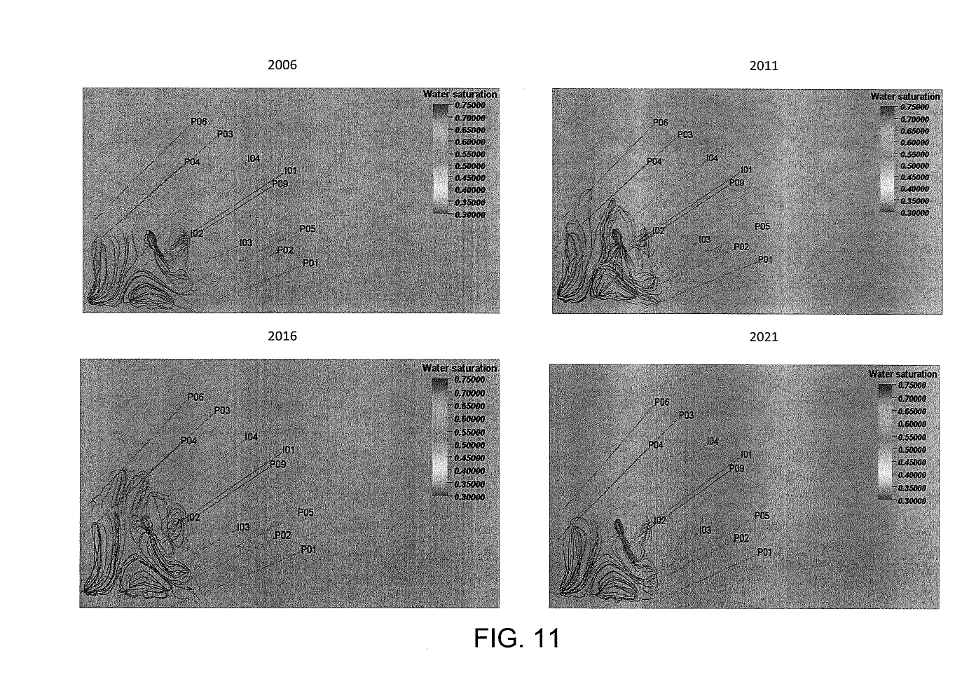

FIG. 11 outlines an illustration of the streamlines for some individual parameters such as the pressure levels, water, oil and gas saturation. The streamlines clearly indicate the flow pattern of the different phases and the convergence towards the producing wells. It also illustrates the complexity of the considered reservoir.

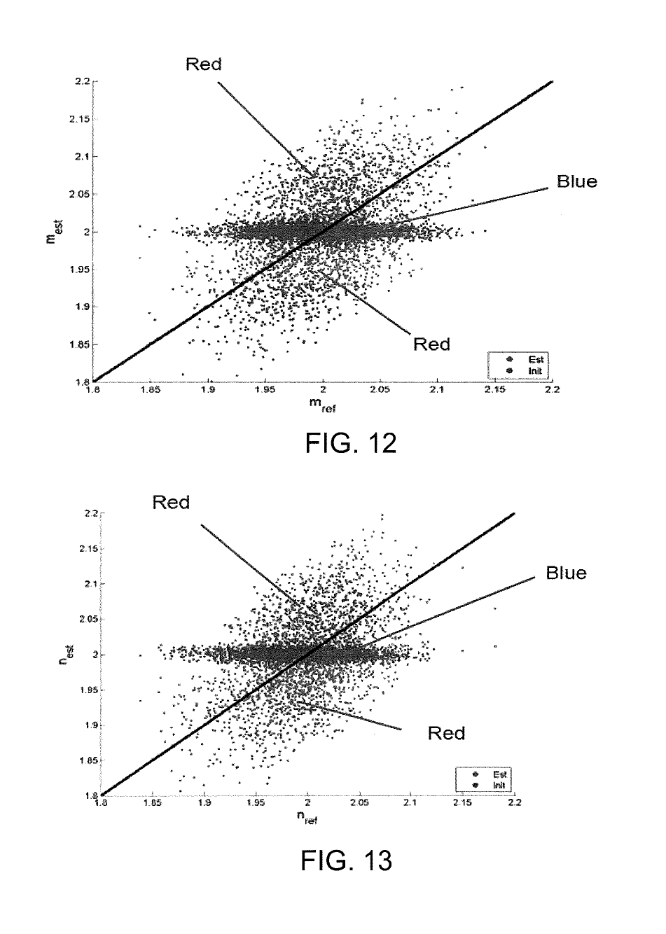

In order to analyze the improvements in the characterization of the reservoir shown in FIG. 12 a cross-plot between the saturation exponents for the initial (blue) and final distribution (red) versus the true water saturation exponent in Archie's Law. The results indicate the ability of the filter to estimate the water saturation exponent that has been outlined in the better matching. A similar conclusion can be drawn for the cementation exponent outline in FIG. 13. In both cases the initial (blue) distribution centers about nₑₛₜ having a value of about 2 along the x-axis.

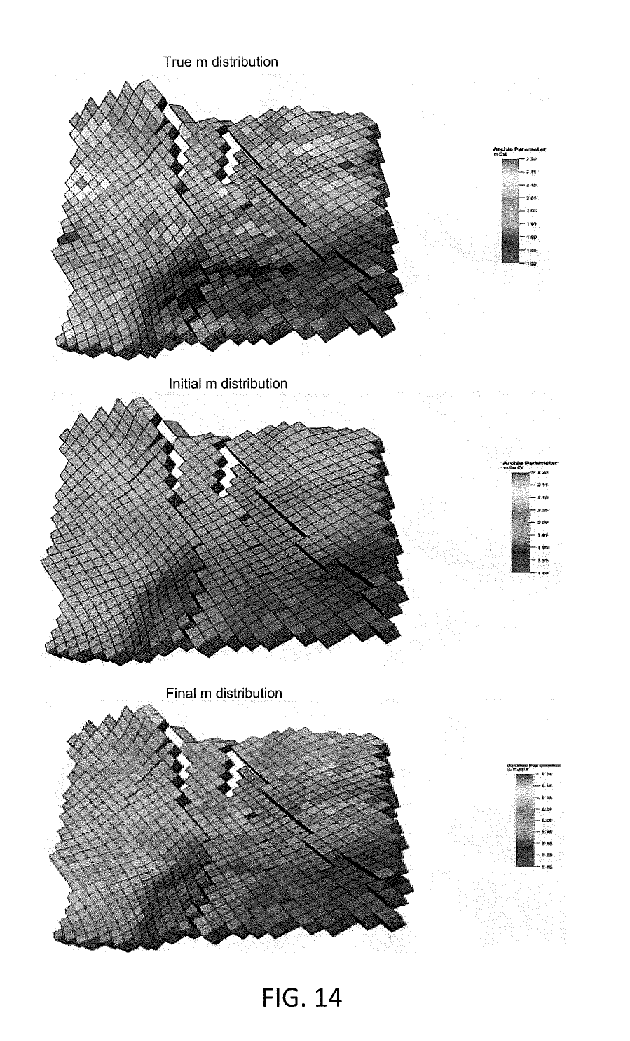

FIG. 14 graphically illustrates the improvement obtained in the water saturation exponent m distributions of the true field, initial and final. As outlined before the assimilation of the water saturation and cementation exponent leads to an improvement in the estimation, and the distribution of the analyzed ensembles exhibits a closer resemblance and heterogeneity as the real one.

### IV. CONCLUSIONS

Electromagnetic techniques have experienced unprecedented growth for reservoir imaging applications, enabling the enhanced detection of propagating water fronts and hydrocarbon bearing spots. While EM imaging and resistivity logging tools have seen considerable technological improvements, relating the conductivity distribution to reservoir properties has continued to be a challenge. Experimental results have outlined that Archie's exponents may vary significantly within the reservoir and hence necessitate subsurface calibration. We present herein an estimation framework for the calibration of Archie's exponents to the reservoir to improve the exactness of the electrical conductivity field and lead to a better characterization of the reservoir rock properties. Matching reservoir production data together with EM attributes leads to considerable history matching improvement and subsurface parameter estimation as well as more accurately relating reservoir properties to the conductivity field. The presented approach has shown amongst the first that estimates the exponents in Archie's Law for a full reservoir field, thereby effectively taking into account the uncertainty in the parameters and more accurately relating the conductivity distribution to water saturation and porosity values.

Although the reservoir forecasting application, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2A and 2B show the functionality and operation of an implementation of portions of the present reservoir resistivity characterization application. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although the flowcharts of FIGS. 2A and 2B show a specific order of execution, it is understood that the order of execution may differ from that which is depicted. For example, the order of execution of two or more blocks may be scrambled relative to the order shown. Also, two or more blocks shown in succession in FIGS. 2A and 2B may be executed concurrently or with partial concurrence. Further, in some embodiments, one or more of the blocks shown in FIGS. 2A and 2B may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the reservoir forecasting application, that comprises software or code can be embodied in any non-transitory computer-readable medium for use by or in connection with an instruction execution system such as, for example, a processor in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the reservoir forecasting application, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device, or in multiple computing devices in the same computing environment. Additionally, it is understood that terms such as “application”, “service,” “system, engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at a one of Z to each be present.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

### REFERENCES

Aanonsen, G., Oliver, D., Reynolds, A., & Vali, B. (2009). The Ensemble Kalman Filter in Reservoir Engineering—a Review. SPE Journal, 14(3), 393-412.
AL-Awad, M. (2001). Evaluating Uncertainty in Archie's Water Saturation Equation Parameters Determination Methods. SPE Middle East Oil Show. Retrieved from https://www.onepetro.org/conference-paper/SPE-68083-MS
Archie, G. (1952). Classification of Carbonate Reservoir Rocks and Petrophysical Considerations. AAPG Bulletin, 36(2), 278-298.
Archie, G. E. (1942). The electrical resistivity log as an aid in determining some reservoir characteristics. Trans. AlMe, 146(99), 54-62. doi:10.2118/942054-G
Archie, G. E. (1947). Electrical resistivity an aid in core-analysis interpretation. AAPG Bulletin, 31(2), 350-366.
Archie, G. E. (1950). Introduction to Petrophysics of Reservoir Rocks. AAPG Bulletin, 34(5), 943-961.
Burgers, G., van Leeuwen, P., & Evensen, G. (1998). Analysis scheme in the ensemble Kalman filter. Monthly Weather Review, 126(6), 1719-1724.
Bussian, A. (1983). Electrical conductance in a porous medium. Geophysics. Retrieved from http://library.seg.org/doi/abs/10.1190/1.1441549
Carothers, J. (1968). A statistical study of the formation actor relation. The Log Analyst, 9(5), 13-20.
Chen, J., & Dickens, T. A. (2009). Effects of uncertainty in rock-physics models on reservoir parameter estimation using seismic amplitude variation with angle and controlled-source electromagnetics data. Geophysical Prospecting, 57(1), 61-74. doi:10.111I/O 365-2478.2008.00721.x
Dresser, A. I. (1982). Well logging and interpretation techniques.
Evensen, G. (1994). Sequential data assimilation with a nonlinear quasi-geostrophic model using Monte Carlo methods to forecast error statistics. Journal of Geophysical Research: Oceans (1978-2012), 99(05), 10143-10162.
GeoQuest, S. (2010). ECLIPSE reservoir simulator. Manual and Technical Description, Houston, Tex.
Hamada, G., & Almajed, A. (2013). Uncertainty analysis of Archie's parameters determination techniques in carbonate reservoirs. Journal of Petroleum.
Hamada, G. M. (2010). Analysis of Archie's Parameters Determination Techniques. Petroleum Science and Technology, 28(1), 79-92.
Hill, H., & Milburn, J. (2003). Effect of clay and water salinity on electrochemical behavior of reservoir rocks, SPE Reprint Series, 31-38.
J. Glover, P. W. (2010). A generalized Archie's law for n phases. Retrieved from http://library.seg.org/doi/abs/10.1190/1.3509781
Jin, G., Torres-Verdin, C., & Devarajan, S. (2007). Pore-scale analysis of the Waxman-Smits shaly-sand conductivity model. Petrophysics. Retrieved from http://cat.inist.fr/?aModele=afficheN&cpsidt=18721067
Leveaux, J., & Poupon, A. (1971). Evaluation Of Water Saturation In Shaly Formations. The Log Analyst. Retrieved from https://www.onepetro.org/journal-paper/SPWLA-1971-vXIIn4a1
Luo, X., & Hoteit, I. (2013). Efficient particle filtering through residual nudging. Quarterly Journal of the Royal Meteorological Society,
Maute, R., Lyle, W., & Sprunt, E. (1992). Improved Data-Analysis Method Determines Archie Parameters From Core Data (includes associated paper 24964). Journal of Petroleum Technology. Retrieved from https://www.onepetro.org/journal-paperiSPE-19399-PA
Mavko, G., Mukerji, T., & Dvorkin, J. (2009). The rock physics handbook: Tools for seismic analysis of porous media. Cambridge University Press.
Nikravesh, M., & Aminzadeh, F. (2001). Past, present and future intelligent reservoir characterization trends. Journal of Petroleum Science and Engineering. Retrieved from http://www.sciencedirect.com/science/article/pii/S0920410501001218
Poupon, A., & Leveaux, J. (1971). Evaluation of water saturation in shaly formations. SPWLA 12th Annual Logging Symposium. Retrieved from https://www.onepetro.org/conference-paper/SPWLA-1971-0
Revil, A., & Glover, P, (1998). Nature of surface electrical conductivity in natural sands, sandstones, and clays, Geophysical Research Letters. Retrieved from http://onlinelibrary.wiley.com/doi/10.1029/98GL00296/full
Shang, B., Hamman, J., & Caldwell, D. (2004). Water Saturation Estimation Using
Equivalent Rock Element Model. SPE Annual Technical . . . Retrieved from https://www.onepetro.org/conference-paper/SPE-90143-MS
Talabani, S., Boyd, D., Wazeer, F. El, & Arfi, S. AL (2000). Validity of Archie Equation in
Carbonate Rocks. Abu Dhabi International . . . Retrieved from https://www.onepetro.org/conference-paper/SPE-87302-MS
Tixier, M., & Alger, R. (1970). Log evaluation of nonmetallic mineral deposits. Geophysics, 35(1), 124-142.
Waxman, M., & Smits, L. (2003), Electrical conductivities in oil-bearing shaly sands. SPE Reprint Series. Retrieved from http://www.pe.tamu.edu/blasingame/Data/z_zCourse_Archive/P663_03C/P663_03C_TAB_Ref_FormEval/SPE_01863_Waxman_Smits_Shaly_Sand_Sw_Relation.pdf
William R. Moore, Y. Z. M. J. U. T. B. (2011). Uncertainty Analysis in Well-Log and Petrophysical Interpretations, 17-28. doi:10.1306/13301405M963478
Winsauer, W. (1952). Resistivity of brine-saturated sands in relation to pore geometry. AAPG Bulletin, 36(2), 253-277.

1. A computer-implemented method for characterizing a reservoir field, comprising:
executing, by the computing device, a reservoir field simulator based at least in part on a geological model;
generating, by the computing device, observational data sets based at least in part on a current state of the reservoir field simulator by querying an observation module, the observational data sets being stored in memory;
generating, by the computing device, a forecasted reservoir field dynamics state over a period of time to at least the current reservoir field simulator state and the observational data;
determining, by the computing device, a conductivity distribution of the field of the reservoir based on the forecasted reservoir field dynamics;
recording, by the computing device, production data of the reservoir field; and
updating, by the computing device, the current reservoir field state including updating one or more reservoir field parameters in the reservoir field simulator based on the determined conductivity distribution and the recorded production data.

2. The method of claim 1, wherein generating the observational data sets, generating the forecasted reservoir field dynamics state, determining the conductivity distribution, recording production data, and updating the current reservoir field simulator state are repeated until a termination criteria is met.

3. The method of claim 1, wherein the forecasted reservoir field dynamics state is generated applying history matching and the history matching comprises a Bayesian filtering, smoothing or direct inversion technique.

4. The methods of claim 3, wherein a Bayesian filtering, smoothing or direct inversion method can comprise an Ensemble Kalman Filter technique.

5. The method of claim 1, wherein the geological model defines at least one of a geological structure, a number of wells, a pressure, a saturation, a permeability, or a porosity.

6. The method of claim 1, wherein the one or more reservoir field parameters include one or more Archie's Law parameters of water saturation and cementation or porosity, the geological model including a model of salt concentration in the reservoir field, wherein the step of determining a conductivity distribution of the field of the reservoir is based on the model of salt concentration, and the step of updating the current reservoir field state includes updating one or more of the Archie's parameters in the reservoir field simulator.

7. The method of claim 1, wherein the observation module is an electromagnetic (EM) survey module configured to calculate a time lapse conductivity response based at least in part on a porosity data and a salt concentration data, and wherein one of the at least two observational data sets comprises the time lapse conductivity response.

8. The method of claim 1, wherein the one or more reservoir field parameters are estimated by assembling the data into an ensemble, integrating the ensemble forward in time to forecast the ensemble, determining moments of a state vector of the forecasted ensemble, and updating the forecasted ensemble with at least some of the production data.

9. The method of claim 1, wherein the updated one or more parameters are returned to the reservoir field simulator.

10. The method of claim 1, wherein the reservoir field simulator generates a graphical user interface for rendering a display device, and the updating of the reservoir field parameters causes an updating of the graphical user interface.

11. A system for characterizing a reservoir field, comprising:
at least one computing device comprising a processor and a memory; and program instructions that, when executed cause the at least one computing device to:
initialize a reservoir field simulator based at least in part on a geological model;
generate observational data sets based at least in part on a current state of the reservoir field simulator by querying an observation module;
generate a forecasted reservoir field dynamics state over a period of time to at least the current reservoir field simulator state and the observational data;
determine a conductivity distribution of the field of the reservoir based on the forecasted reservoir field dynamics;
record production data of the reservoir field; and
update the current reservoir field state including update of one or more reservoir field parameters based on the determined conductivity distribution and the recorded production data.

12. The system of claim 11, wherein the generating the observational data sets, the simulating the forecasted reservoir field dynamics state, determining the conductivity distribution, recording production data, and the updating the current reservoir field simulator state are repeated until a termination criteria is met.

13. The system of claim 11, wherein the forecasted reservoir field dynamics state is generated applying history matching and the history matching comprises a Bayesian filtering, smoothing or direct inversion technique.

14. The system of claim 13, wherein the ensemble-based filter technique can comprise an Ensemble Kalman Filter technique.

15. The system of claim 11, wherein the geological model defines at least one of a geological structure, a number of wells, a pressure, a saturation, a permeability, or a porosity.

16. The system of claim 11, wherein the one or more reservoir parameters include one or more Archie's Law parameters of water saturation and cementation or porosity, the geological model including a model of salt concentration in the reservoir field, wherein the step of determining a conductivity distribution of the field of the reservoir is based on the model of salt concentration, and the step of updating the current reservoir field state includes updating one or more of the Archie's parameters in the reservoir field simulator.

17. The system of claim 11, wherein the observation module is an electromagnetic (EM) survey module configured to calculate a time lapse conductivity response based at least in part on a porosity data and a salt concentration data, and wherein one of the at least two observational data sets comprises the time lapse conductivity response.

18. The system of claim 11, wherein the one or more reservoir field parameters are estimated by assembling the data into an ensemble, integrating the ensemble forward in time to forecast the ensemble, determining moments of a state vector of the forecasted ensemble, and updating the forecasted ensemble with at least some of the production data.

19. The system of claim 11, wherein the updated one or more parameters are returned to the reservoir field simulator.

20. The system of claim 11, wherein the reservoir field simulator generates a graphical user interface for rendering a display device, and the updating of the reservoir field parameters causes an updating of the graphical user interface.
